(19) United States
(12) Patent Application Publication
(10) Pub. No.: US 2014/0205981 A1
(43) Pub. Date: Jul. 24, 2014

(54) DIALYSIS TREATMENT SIMULATION SYSTEMS AND METHODS

(71) Applicant: FRESENIUS MEDICAL CARE HOLDINGS, INC., Waltham, MA (US)

(72) Inventor: Patricia A. Ryder, West Roxbury, MA (US)

(73) Assignee: Fresenius Medical Care Holdings, Inc., Waltham, MA (US)

(21) Appl. No.: 13/744,983

(22) Filed: Jan. 18, 2013

(51) Int. Cl. G09B 19/00

(52) U.S. Cl. CPC G09B 19/00
USPC 434/262

(57) ABSTRACT

A dialysis treatment simulation system and method are provided that comprise a treatment simulator, a computing module, and a user interface. The treatment simulator generates an event notification that simulates a notification of an event related to an interaction between a dialysis treatment machine and a patient. The computing module generates a request for a user action in response to the simulated event notification. The user interface outputs the simulated event notification and the request for the user action to an output device and provides a received user response to the computing module.

### BACKGROUND

Dialysis machines are well known for treating medical conditions related to renal failure, where a person's kidneys inadequately filter toxins and waste products from the blood. One type of a dialysis procedure is referred to as hemodialysis, wherein blood is removed from the patient and output to a dialyzer associated with a hemodialysis machine. The patient's blood circulates along one side of a semipermeable synthetic membrane in the dialyzer, referred to as an extracorporeal circuit (ECC). A dialysate solution is provided by a dialysate delivery system, and flows between the dialysate delivery system and the hemodialysis machine along the opposite side of the membrane, referred to as a dialysate circuit, to remove waste, toxins, and other undesirable products from the blood. Other dialysis procedures involve a peritoneal treatment, which employs a natural membrane from a patient's own body.

A dialysis machine typically includes various meters, sensors, and other event detection and monitoring systems positioned along the ECC and the dialysate circuit to monitor an array of safety-critical parameters and to detect abnormal events occurring prior to or during a dialysis procedure. The parameters are typically displayed as text, graphics, and the like at a control panel monitor, touchscreen, or other display. A dialysis machine operator monitors the display during a treatment for abnormal events, and can make any necessary adjustments if an abnormal event occurs. Inadequately trained hemodialysis machine operators can cause patient injury or death during a treatment.

### BRIEF SUMMARY

In accordance with one aspect, provided is a medical treatment simulation system comprising a treatment simulator, a dialysis treatment simulation system, comprising a treatment simulator, a computing module, and a user interface. The treatment simulator simulates an event notification related to an interaction between a dialysis treatment machine and a patient. The computing module generates a request for a user action in response to the simulated event notification. The user interface outputs the simulated event notification and the request for the user action to an output device and provides a received user response to the computing module.

In an embodiment, the computing module generates a multiple choice question and one or more possible answers to the multiple choice question, and wherein the received user response includes a user-selected answer of the one of the computer module-generated possible answers.

In an embodiment, the computing module generates a question and a blank field, and wherein the user action includes entering a response to the question in the blank field.

In an embodiment, the computing module processes a response to the request for the user action input to the user interface by an operator.

In an embodiment, the treatment simulator generates simulation data related to the interaction between the dialysis treatment machine and the patient, the simulation data simulating treatment parameters related to the interaction between the dialysis treatment machine and the patient.

In an embodiment, the event notification is displayed in response to a simulated treatment parameter exceeding a treatment parameter threshold.

In an embodiment, the event notification simulates at least one of an alarm notification, a warning notification, or a status advisory notification.

In an embodiment, the event notification simulates an abnormal event related to a dialysis treatment.

In an embodiment, the user interface provides the event notification with a graphical element to a visual display.

In an embodiment, the graphical element includes at least one of a window, a menu, a radio button, a check box, a status box, an icon, or a display field.

In an embodiment, the dialysis treatment simulation system further comprises a results processor that determines from the received user response a competence level of a user with respect to operating the dialysis treatment machine.

In an embodiment, the output device is at least one device selected from a computer display, a tablet computer, and a mobile device.

In an embodiment, the dialysis treatment simulation system further comprises a timer that determines whether a user responds to a presented question within a predetermined period of time.

In an embodiment, the system is operated by at least one of a healthcare practitioner, a dialysis patient, or a technical service personnel for training on the operation of the dialysis treatment machine.

In accordance with an aspect, provided is a computer-implemented method for performing a dialysis treatment simulation. An event notification is generated that simulates an event notification related to an interaction between a dialysis treatment machine and a patient. A request is generated for a user action in response to the simulated event notification. The simulated event notification and the request for the user action are output to an output device. A received user response to the request for the user action is processed.

In an embodiment, outputting the request includes displaying, at a treatment display, a menu of options for a user to select from.

In an embodiment, at least one of the menu options corresponds to a correct action for addressing the displayed simulated event notification.

In an embodiment, generating an event notification comprises executing computer code that simulates the event notification.

In accordance with another aspect, provided is a method of simulation for training a trainee of a dialysis treatment machine. An event notification related to a simulated dialysis treatment is displayed at a display. A response activation is performed. A question regarding the displayed event notification is displayed at a display. A response to the question is processed.

In an embodiment, the response activation includes selecting a button at the display.

In an embodiment, displaying the question includes displaying, at the display, a menu of options for a user to select from.

In an embodiment, method further comprises generating a multiple choice question and one or more possible answers to the multiple choice question; and selecting an answer of the one or more possible answers as the response.

In an embodiment, the method further comprises generating a question and a blank field; and entering the response at the blank field.

In an embodiment, the event notification simulates a notification of an event related to an interaction between the dialysis treatment machine and a patient.

In an embodiment, the method further comprises generating simulation data related to the interaction between the dialysis treatment machine and the patient, the simulation data simulating treatment parameters related to the interaction between the dialysis treatment machine and the patient.

In an embodiment, the event notification simulates at least one of an alarm notification, a warning notification, or a status advisory notification.

In an embodiment, the event notification simulates an abnormal event related to a dialysis treatment.

In an embodiment, the method further comprises determining from the response a competence level of a user entering the response with respect to user operating the dialysis treatment machine.

In an embodiment, the method further comprises determining whether a user responds to a presented question within a predetermined period of time.

In accordance with another aspect, provided is a system for training a trainee about a self-care medical procedure. The training system comprises a computing module that includes an operation to be learned related to a dialysis treatment, the computing module constructed and arranged to generate a request for a user action related to the operation to be learned; a simulated treatment display screen that displays the request; and a results processor that processes a response to the request and provides a training result in response to the processed response.

In accordance with another aspect, provided is a computer program product for simulation. The computer program product comprises a computer readable storage medium having computer readable program code embodied therewith. The computer readable program code comprises computer readable program code configured to simulate an event notification related to an interaction between a dialysis treatment machine and a patient; computer readable program code configured to generate a request for a user action in response to the simulated event notification; computer readable program code configured to output the simulated event notification and the request for the user action to an output device; and computer readable program code configured to process a received user response to the request for the user action.

### BRIEF DESCRIPTION

The above and further advantages of embodiments of the present inventive concepts may be better understood by referring to the following description in conjunction with the accompanying drawings, in which like numerals indicate like structural elements and features in various figures. The drawings are not necessarily to scale, emphasis instead being placed upon illustrating the principles of the invention.

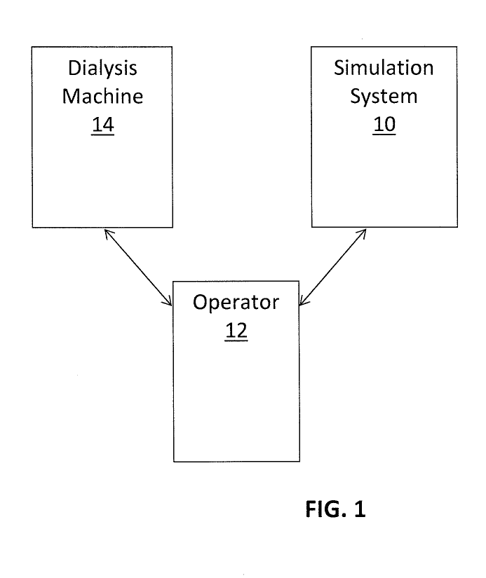

FIG. 1 is a block diagram of a system that performs a simulated dialysis treatment, in accordance with an embodiment;

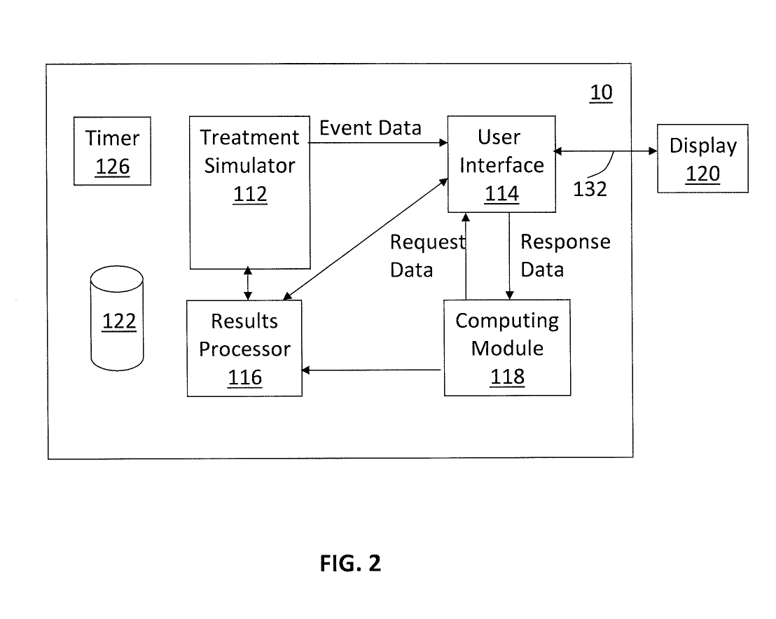

FIG. 2 is a schematic block diagram of a dialysis treatment simulation system, in accordance with an embodiment;

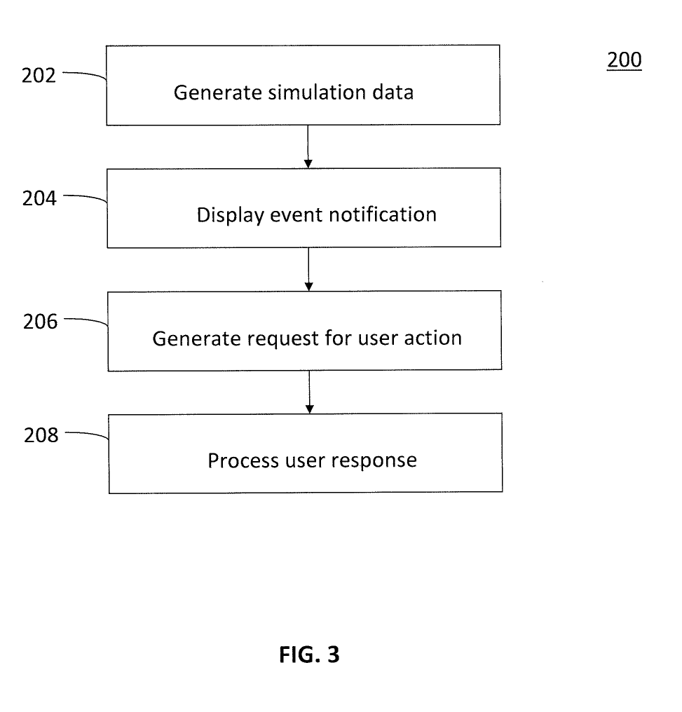

FIG. 3 is a flowchart illustrating a method for operating a dialysis treatment simulation system, in accordance with an embodiment;

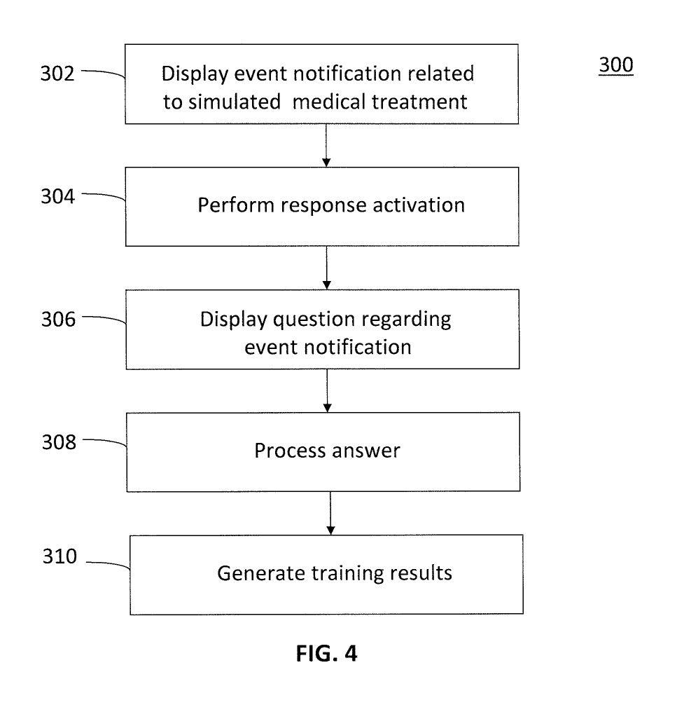

FIG. 4 is a flowchart illustrating a method for training a trainee to perform a dialysis treatment, in accordance with an embodiment;

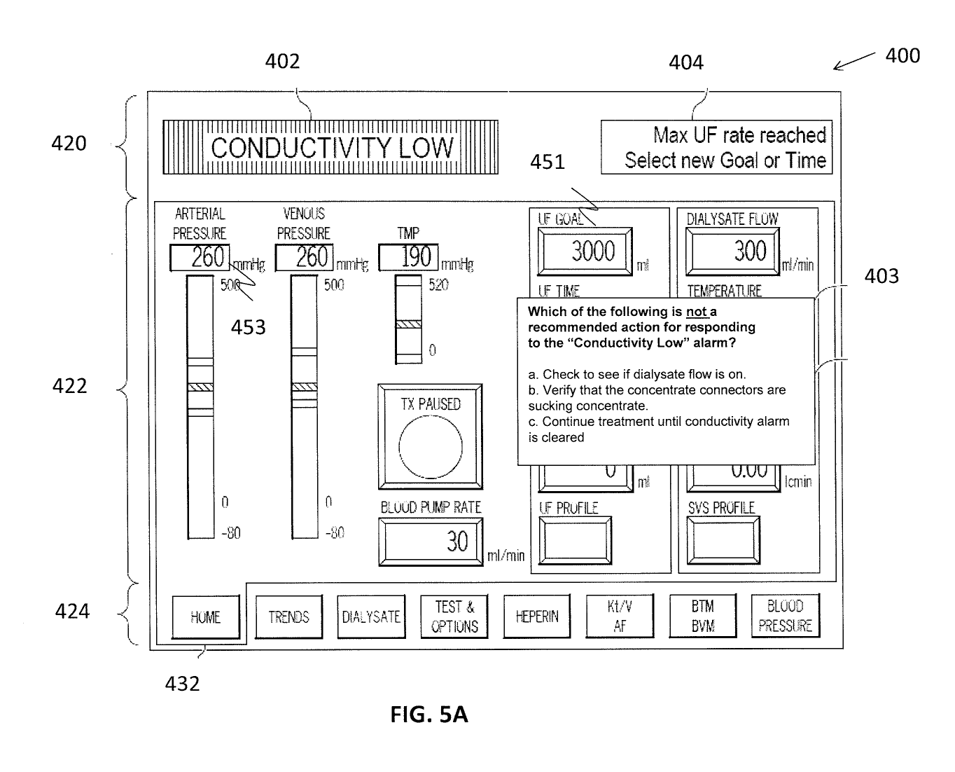

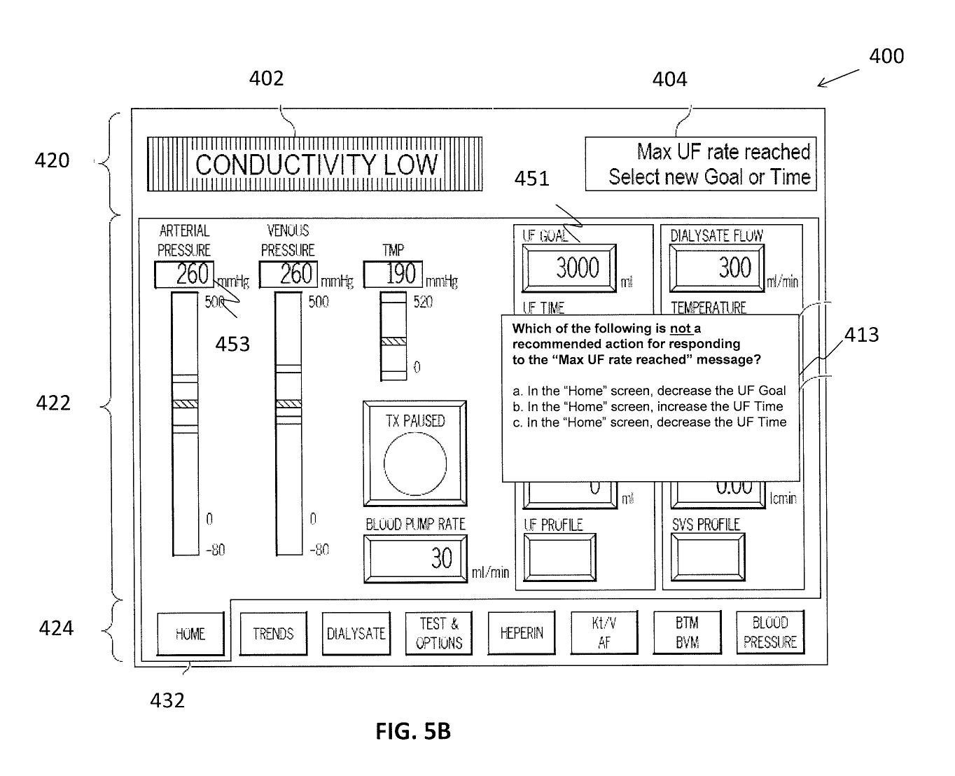

FIGS. 5A and 5B are screenshots of a dialysis treatment simulator display screen, in accordance with an embodiment; and

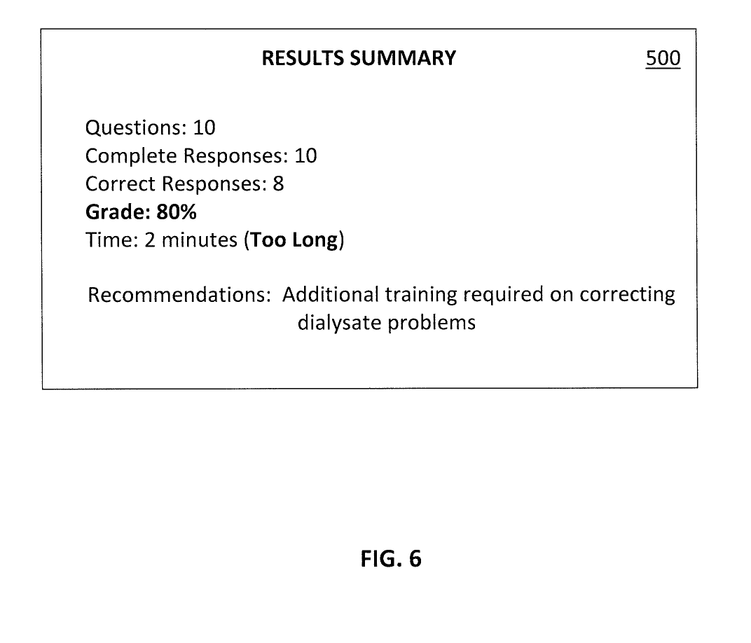

FIG. 6 is an illustration of feedback provided to a trainee in response to a test performed in a simulated environment, in accordance with an embodiment.

### DETAILED DESCRIPTION

Embodiments will now be described more fully hereinafter with reference to the accompanying drawings, in which embodiments of the inventive concepts are shown. This invention may, however, be embodied in many different forms and should not be construed as limited to the embodiments set forth herein. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure. As used herein, the term “and/or” includes any and all combinations of one or more of the associated listed items and may be abbreviated as “/”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent,” etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

In brief overview, aspects of the present inventive concepts include systems and methods for simulating a treatment performed by a medical device, preferably a dialysis machine or a related apparatus, on a person or animal. A dialysis treatment simulation system can be used to train new users such as medical technicians, nurses, dialysis patients, technical service personnel or other healthcare practitioners, caretakers, or homecare patients to operate a hemodialysis, peritoneal, portable, home, wearable, or regenerative dialysis device in a simulated environment, for example, simulating a Fresenius 2000T hemodialysis machine, a Fresenius Liberty Cycler™ peritoneal dialysis system, or a Fresenius 2008K@Home™ hemodialysis delivery system, each provided by Fresenius Medical Care North America. Accordingly, in some embodiments, a dialysis treatment simulation system can be used to demonstrate a predetermined level of user competency as a prerequisite for operating an actual dialysis machine to treat patients, thereby reducing a risk of error during a treatment due to inexperience or poor clinical practice.

A dialysis treatment simulation system can alternatively be used to evaluate a new product during its design and development or clinical trials, for example, simulating new features or functions. Other applications can equally apply where embodiments of a dialysis treatment simulation system and method are applied to demonstrate user competency before operating a “real life” dialysis treatment machine, i.e., a machine connected to a patient for performing a treatment. The systems and methods in accordance with embodiments of the present inventive concepts can comply with well-known regulations, standards, or requirements, for example, U.S. or international standards such as ISO/IEC 62366.

FIG. 1 is a block diagram of a system that performs a simulated dialysis treatment, in accordance with an embodiment. An operator 12 is in communication with a dialysis treatment simulation system 10 and a dialysis machine 14, also referred to as a dialysis treatment machine, for example, a peritoneal, hemodialysis, portable, home, wearable, or regenerative or non-regenerative dialysis machine. The operator 12, the dialysis treatment simulation system 10, and the dialysis machine 14 can be co-located. For example, the simulation system 10 can be directly coupled and adjacent the dialysis machine 14 during a simulated treatment, and the operator 12 can be positioned in front of a display connected to the simulation system 10. Alternatively, the dialysis treatment simulation system 10 and a dialysis machine 14 can be co-located under a same hardware platform. Alternatively, the operator 12, the simulation system 10, and the dialysis machine 14 can be at different locations and in communication with each via a local area network (LAN), a wide area network (WAN), a mobile network, and/or other communication network known to those of ordinary skill in the art. The dialysis machine 14 can be optional, and its presence is not required for operating the simulation system 10 or for performing methods in accordance with embodiments, for example, described herein. In some embodiments described herein, the dialysis machine is non-operational.

Regardless of whether the dialysis machine 14 is provided for a simulation, the dialysis treatment simulation system 10 can simulate events related to an operation performed by the dialysis machine 14, and/or other regenerative or non-regenerative dialysis machine, or other medical treatment device known to those of ordinary skill in the art. Some or all operations related to the systems and methods described herein can be performed at the dialysis treatment simulation system 10. For example, computation units such as the treatment simulator 112 described in FIG. 2 can comprise software modules that operate on, or in connection with, one or more processors, and/or other firmware or hardware.

The dialysis machine 14 can, in some embodiments, be non-operational and therefore unable to perform an actual dialysis treatment. In other words, the dialysis machine 14 can operate as a faux dialysis machine, which mimics operational aspects of a real-life hemodialysis machine or other medical treatment device. Physical components of the dialysis machine 14, such as sensors, meters, buttons, switches, flow valves, filters, and so on, can provide the operator 12 with a visual and sensory experience under a controlled simulated environment. Here, the simulator operator 12 can perform simulated operational steps by having physical contact with these components. For example, the operator 12 can view and “adjust” a dialysate line at the dialysis machine 14 in response to a “Dialysate Pressure Low” alarm displayed at the simulation system 10.

Alternatively, the dialysis machine 14 can be constructed and arranged to include a dialysis mode and a simulation mode. In the dialysis mode, the dialysis machine 14 can be operational, i.e., an operator 12 can perform an actual dialysis treatment on a patient. However, in the simulation mode, the dialysis machine 14 is non-operational, but provides physical aspects of a dialysis treatment without being connected to a patient, permitting the operator 12 to engage in a simulated dialysis treatment from the simulation system 10 using the dialysis machine 14 for a visual and sensory experience during the simulation. In an embodiment, aspects of a dialysis mode can be provided for use in a simulation mode. For example, a fluid that simulates a patient's blood can be received by the dialysis machine 14 and/or the simulation system 10 and perceived by sensors at the dialysis machine 14 and/or the simulation system 10 to be “real” blood. Here, the fluid can have a temperature at or near a human body temperature. A temperature sensor can capture the fluid temperature, which can be presented to the simulation system 10 for use in a simulation.

As shown in FIG. 2, the dialysis treatment simulation system 10 includes a treatment simulator 112, a user interface 114, a results processor 116, a computing module 118, a data repository 122, and a timer 126, each of which can be configured in hardware, software, or a combination thereof. Each of these elements can communicate with one another and/or other elements of the dialysis treatment simulation system 10 via a data bus or the like (not shown).

The treatment simulator 112 can simulate one or more functions of all different types of dialysis devices, including a hemodialysis, peritoneal, portable, home, wearable, regenerative, or non-regenerative dialysis device, such as the dialysis machine 14 shown in FIG. 1. It is well-known that a typical hemodialysis machine includes various monitors, meters, sensors, detectors, and the like that monitor an array of safety-critical parameters prior to or during a dialysis procedure, which can include but not be limited to blood and dialysate flow rates, temperature, arterial and venous pressure, dialysis solution conductivity, temperature, and ultrafiltration (UF) control parameters.

The treatment simulator 112 can execute one or more programs, which can provide hypothetical models of various known interactions between a dialysis machine and a patient to generate simulation data. The treatment simulator 112 can execute a simulated scenario on the system 10 that specifies a state of a patient experiencing a medical condition, and can generate simulation data related to the scenario.

The simulation data generated by the treatment simulator 112 can relate to abnormal conditions that occur during a treatment. The simulation data can include safety-critical data such as blood and dialysate flow rates, temperature, venous and arterial pressure, and dialysis solution conductivity, which represents actual parameters generated in response to a real-life dialysis treatment. For example, the treatment simulator 112 can display a high dialysate temperature, for example, 104° F. The simulation data can include an alarm or other event notification that is similar to an actual event notification generated when a patient's blood pressure or other vital parameter is abnormally high, low, or otherwise beyond an acceptable range. An event notification of such an alarm is displayed when a simulated treatment parameter exceeds a treatment parameter threshold, for example, when the patient's blood pressure exceeds a predetermined value corresponding to an acceptable blood pressure. The simulated event notifications can be generated randomly by the treatment simulator 112 among a set of data stored at the data repository 122. Alternatively, the simulated alarm can be selected by the operator 12 as part of a test or sequence of simulation exercises. In this example, related simulation data such as a current blood pressure can be provided by the treatment simulator 112 for display.

The treatment simulator 112 can be responsive to a user response with respect to the simulation data. Referring to the previous example, the operator 12 can use the displayed simulation data to determine a proper action to clear the high blood pressure alarm. The operator 12 can enter a response, e.g., select an action for clearing the high blood pressure alarm, via the user interface 114 to the computing module 118 using an input device such as a keypad or touchscreen interface in communication with a display 120. The computing module 118 can determine from a user response whether the operator 12 provided the proper response for addressing the alarm, e.g., selected the proper step or sequence of steps for lowering a patient's blood pressure. The computing module 118 can clear the alarm in response to the correct response provided by the operator 12.

The user interface 114 permits the operator 12 to interact with the treatment simulator 112, the results processor 116, and/or the computing module 118, for example, by performing actions on the simulated system, for example, to observe treatment results and to modify displayed parameters or other event data. The user interface 114 can include a graphical user interface application or other program for providing graphical elements such as windows, menus, radio buttons, check boxes, status boxes, icons, display fields, or other static or discrete objects.

The display 120 can be in electronic communication with the dialysis treatment simulation system 10, for example, via a data connector 132 known to those of ordinary skill in the art, for example, an Ethernet or RS-232 connector. The display 120 includes a screen, and can include other I/O devices such as a keypad, mouse, keyboard, touchscreen interface, microphone, or speakers. Other input or output devices can equally apply, such as a voice recognition device that permits a user to establish electronic communication with the dialysis treatment simulation system 10. The user interface 114 displays information to the display 120 that is related to a simulated interaction between a medical treatment machine and a patient. The operator 12, in turn, can provide response information via the display 120 and the user interface 114 to the system 10.

The computing module 118 generates a concept or operation to be learned from the simulated data presented at the display 120. One or more concepts or operations can be generated from a set of training modules stored at the data repository 122. Each training module can include pre-scripted troubleshooting scenarios, parameter data corresponding to the scenarios, for example, blood pressure, dialysate flow rates, and so on, which can be presented at the display 20 as part of, for example, one or more steps of, a medical treatment-related concept or operation. The concept or operation to be learned is presented to the display 120 in the form of one or more multiple choice questions, true/false questions, incomplete sentences, or other related requests that can test the operator's competency with respect to operating the dialysis machine 14 being simulated. The computing module 118 can generate the request data to be related to a displayed alarm or other event notification that simulates a notification of an event related to an interaction between the dialysis treatment machine 14 and a patient. For example, as shown at FIGS. 5A and 5B, an event notification such as a “Conductivity Low” alarm can be presented at the display 120. The computing module 118 can provide one or more multiple choice questions or related inquiries stored at the data repository 122 regarding the displayed event notification and, optionally, can provide correct answers and/or incorrect answers corresponding to the questions, referred to as answer options. The computing module 118 can detect a user response, for example, a selected answer to a multiple choice question, and provide the response to the results processor 116.

The timer 126 can be activated when a request for user action is displayed for determining whether the operator 12 responds to a presented question within a predetermined period of time. The timer 126 can be activated when the operator 12 selects a mute button or other trigger, for example, in response to an alarm or other notification, and stopped when the operator 12 submits a response to the system 10.

From this time, a determination can be made how it takes an operator 12, for example, a trainee, to respond to the questions. The timer 126 can determine an amount of time taken for the operator 12 to respond to one or more presented requests, for example, and can provide this data to the results processor 116.

The results processor 116 can store the received user results, and generate analysis data such as reports or the like for determining whether the operator 12 is sufficiently competent to operate a dialysis machine that the dialysis treatment simulation system 10 is simulating. For example, the operator 12 can participate in a test where several multiple choice questions are presented. The operator 12 can select an answer that the operator 12 feels is the most correct. The results processor 116 stores the selected answer at the data repository 122. The results processor 116 can also store timing results determined by the timer 126. The results processor 116 can compile operator responses and generate a report or other analysis data, for example, to provide a result or other feedback for the operator 12, a supervisor, or other interested party.

FIG. 3 is a flowchart illustrating a method 200 for operating a dialysis treatment simulation system, in accordance with an embodiment. Some or all of the method 200 can be performed on the dialysis treatment simulation system 10 and/or the display 120 described herein.

At block 202, simulation data is generated. The simulation data can include data related to an operation of a medical device such as the dialysis machine 14 of FIG. 1, or other dialysis system. The simulation data can include simulated parameters that represent actual parameters generated in response to a real-life dialysis treatment, for example, safety-critical data referred to herein. The simulation data can include event notifications, such as alarms, warnings, status advisory messages, or other informational messages that simulate a notification of an event related to an interaction between a dialysis treatment machine and a patient.

At block 204, the simulated event notification, i.e., alarm notification, warning notification, an advisory message, and so on can be displayed in a status box, window, or the like presented by the user interface 114 at a display 120. For example, referring to FIGS. 1, 5A, and 5B, an operator can attempt to enter a treatment parameter that is outside an allowable range, whereby the treatment simulator 112 generates a simulated dialog message “Maximum UF rate reached . . . . ” In another example, also referring to FIGS. 1, 5A, and 5B, the treatment simulator 112 can generate a simulated “Conductivity Low” alarm, an advisory message, or the like, indicating that a dialysate conductivity is insufficient, noting that a dialysate conductivity is not determined. In this case, the treatment simulator 112 generates the message from hypothetical model data stored at the data repository 122.

At block 206, a request is generated for a user action to be taken. For example, the computing module 118 can generate one or more questions along with a number or menu of choices to select from, including an associated correct answer and one or more incorrect answers. The questions and associated answers can be predefined and stored at the data repository 122. The questions and answers can be organized according to topics or training modules. For example, a training module may include all questions and answers related to a particular operation such as events related to maintaining a proper blood pressure. In this manner, the operator 12 can be trained on one topic at a time. The training modules can be arranged in a manner that allows an operator to preselect a topic, or, alternatively, receive displayed topic information in a random order. The timer 126 (see FIG. 2) can be activated to ensure that each question is answered within a predetermined period of time, or that each set of questions is timely answered.

Other requests for a user action can include completing a questionnaire, i.e., filling in blanks in response to a set of presented questions, or the like. Here, the simulation system 10 can include artificial intelligence processors or the like to determine whether an answer provided in a blank is a valid response. In other embodiments, a request includes asking the operator 12 to perform a physical function at the dialysis machine 14, for example, to adjust a valve, then to select an appropriate button or the like at the display 20 indicating that the task is completed.

At block 208, the user response to the request is processed. For example, a response to a multiple choice question can be provided to the results processor 116 to determine whether the answer provided by the operator 12 is the correct answer.

After the user answers the question, another question can appear that corresponds to the same event notification, or a different event notification can be displayed, and questions pertaining to the newly displayed event notification can be presented. A request can be displayed in a window, subscreen, or the like, asking if the operator 12 wants to receive additional questions. The timer 126 can be activated to measure the amount of time taken to respond to one or more questions. This data can be provided to the results processor 116 for processing and/or storage at the data repository 122.

FIG. 4 is a flowchart illustrating a method 300 for training a trainee to perform a dialysis treatment, in accordance with an embodiment. Some or all of the method 300 can be performed on the dialysis treatment simulation system 10 and the display 120 described herein. Accordingly, a trainee can refer to the operator 12 described herein.

At block 302, an event notification is presented at the display 120. The event notification simulates a notification of an event related to an interaction between a dialysis treatment machine and a patient, similar to that described at FIGS. 1-3.

At block 304, the trainee can perform a response activation. For example, the trainee 12 can select a button, key, or other activation mechanism (not shown) from a keyboard, touchscreen, voice recognition device, or other I/O device in communication with the dialysis treatment simulation system 10. In response, at block 306, a window, screen, field, or other object is displayed, which presents the trainee 12 with a question or other request related to the event notification, for example, illustrated at FIGS. 5A and 5B. The displayed question and/or correct answers to the question can be derived from information provided in the Troubleshooting section, or other sections, of the Fresenius 2008T Hemodialysis Machine User's Guide (for example, 2007 edition), the contents of which are incorporated by reference herein in their entirety.

At block 308, the trainee's response is received and processed. For example, a response to a multiple choice question can be processed to determine whether the answer provided by the operator 12 is the correct answer. Timing information from the timer 126 can also be considered, as described herein, to determine whether the operator's response was timely.

At block 310, training results are generated. At the end of a question and answer session, the trainee responses are analyzed by the results processor 116 for determining a competency level of the trainee 12 with respect to understanding the features and functions of the dialysis machine 14 of which the dialysis treatment simulation system 10 performs a simulation. The answers can be classified as correct or incorrect. A result, score, grade, or the like can be calculated from the analysis. The calculated result can be compared with results received from other trainees receiving training from the dialysis treatment simulation system 10. The comparison data can be used to provide the trainee 12 with feedback or other information to improve the trainee's knowledge with respect to performing a dialysis treatment.

FIGS. 5A and 5B are screenshots of a dialysis treatment simulator display screen 400, in accordance with an embodiment. The simulator display screen 400 presents to a trainee or other viewer a set of simulated treatment parameters related to medical procedures such as a dialysis procedure. The display screen 400 can simulate a treatment display screen of a dialysis machine, and permits an operator, for example, operator 12 shown in FIG. 1, to modify and/or monitor simulated treatment parameters before or during a dialysis procedure. Simulation data such as simulated blood and dialysate flow rates, temperature, venous and arterial pressure, and dialysis solution conductivity can be displayed, which represent actual parameters generated in response to a real-life dialysis treatment. The simulation data can include an alarm or other event notification that is similar to an actual event notification generated when a reading, for example, patient's measured blood pressure, is abnormally high, low, or otherwise out of an acceptable range.

The treatment display screen 400 can comprise a status section 420, a treatment display window 422, and a set of treatment simulator screen buttons 424.

The status section 420 includes a status box 402 and a dialog box 404, which display event notification information during a simulated treatment performed by the dialysis machine 14. The status box 402 can display a simulated machine operational mode, for example, a dialysis mode, indicating that a dialysis treatment is in progress. The status box 402 can display event notifications that correspond to simulated abnormal events occurring prior to or during a dialysis treatment, for example, a “Conductivity Low” alarm.

The dialog box 404 displays additional information related to an event. For example, the dialog box 404 can display a “Maximum UF rate reached . . . ” message in response to the training simulator 112 generating a simulation of a user attempting to change the UF rate to a value that is outside an allowable range, or in response to an actual attempt by the operator 12 to modify a UF goal value at a UF Goal edit button 451. The dialog box 404 can alternatively display simulation results related to a set of current measurements, for example, a time of occurrence of a most recent blood pressure reading. Accordingly, when an abnormal event is simulated, for example, a particular treatment parameter exceeding a predetermined range, or an operator entering an unacceptable parameter value, the status box 402 and/or the dialog box 404 can display a notification corresponding to the event.

The treatment display window 422, also referred to as a treatment display section, includes one or more regions for viewing various treatment data, for example, an arterial pressure display region that includes a value field, e.g., displaying a simulated arterial pressure value of 260 mmHg, and a corresponding vertical bar graph for graphically displaying the arterial pressure value. A user can enter values, for example, enter a UF goal value 3000, or the UF goal value can be automatically generated, for example, as part of a training exercise by the dialysis treatment simulation system 10. A request for a user action can be presented that corresponds to the new alarm, for example, a request for a user to enter a recommended action for addressing and removing the new alarm.

The treatment simulator screen buttons 424 permit an operator to access and view the various treatment display screens displayed at the treatment display window 304. A display screen can be part of, or otherwise in communication with, a computer monitor, tablet, telephone, mobile device, or other electronic device. For example, a treatment display screen can include a home screen that is displayed by selecting the Home screen button 432. Although a home treatment display screen is shown and described herein, other display screens can be displayed, depending on the screen button 424 that is selected. For example, a Service Mode button (not shown) can be presented for training technical service or maintenance personnel.

The treatment display screen 400 can display a request for user action in a subscreen 403 in response to the user selecting a response activation mechanism (not shown) such as a mute button. Requests for a response by the operator can be displayed sequentially, each in response to a selection of the activation mechanism. Alternatively, the activation mechanism can be selected once, whereby a predetermined number of requests for a response can be displayed. In one example shown in FIG. 5A, a request can be displayed in the subscreen 403 for the operator 12 to select a recommended action for responding to the Conductivity Low alarm displayed in the status box 402. In another example shown in FIG. 5B, a request can be displayed in the subscreen 403 for the operator 12 to select a recommended action for responding to the “Max UF rate reached” message displayed in the dialog box 404. One or more questions can be displayed for each event. Each question can be presented in a predetermined sequential order. Here, a first question can be presented. If the user answers the first question correctly, then a second question can be presented, and so on. In this example, the second question may not be presented until the first question is correctly answered. Alternatively, second question may be presented even if the first question is incorrectly answered. One or more sub-questions can be displayed after a response is provided to a question, where each sub-question requires a response from the operator 12.

As shown in FIGS. 5A and 5B, the subscreen 403 can display one or more question and multiple answer options, which are predefined and stored at the data repository 122. In other embodiments, the subscreen 403 can display true/false questions, incomplete sentences, or other inquiries that assess the operator's competency with respect to addressing a displayed event notification corresponding to a simulated dialysis treatment. The information displayed at the subscreen 403 can be derived from the Fresenius 2008T Hemodialysis Machine User's Guide (2007), the contents of which are incorporated by reference above.

The computing module 118 can provide the operator's responses to one or more questions via the user interface 114 to the results processor 116. As shown in FIG. 6, the results processor 116 can generate a report 500 or other data results in accordance with embodiments described herein. For example, the results processor 116 can generate a grade, for example, 80% correct, which is provided in the report 500. The report 500 can include other data that can be used to determine the operator's competency with respect to a specific category, for example, a recommendation that the operator 12 receives additional training on correcting dialysate problems. The results processor 116 can also provide results generated by the timer 126.

The report 500 can be stored in the data repository 122. The report 500, also referred to as a results summary, can be displayed in a wide variety of graphical and/or numerical formats, for example, described herein.

As will be appreciated by one skilled in the art, aspects of the present inventive concepts may be embodied as a system, method or computer program product. Accordingly, aspects of the present inventive concepts may take the form of an entirely hardware embodiment, an entirely software embodiment (including firmware, resident software, micro-code, etc.) or an embodiment combining software and hardware aspects that may all generally be referred to herein as a “module” or “system.” For example, a module may be implemented as a hardware circuit comprising custom circuits, gate arrays, off-the-shelf semiconductors such as logic chips, transistors, or other discrete components. A module may also be implemented at programmable hardware devices such as field programmable gate arrays, programmable array logic, programmable logic devices or the like.

Modules may also be implemented at software for execution by various types of processors. An identified module of executable code may, for instance, comprise one or more physical or logical blocks of computer instructions, which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. The modules may be passive or active, including agents operable to perform desired functions.

Furthermore, aspects of the present inventive concepts may take the form of a computer program product embodied in one or more computer readable medium(s) having computer readable program code embodied thereon. A storage device can include a computer readable storage medium, which may be, for example, but not limited to, an electronic, magnetic, optical, electromagnetic, infrared, or semiconductor system, apparatus, or device, or any suitable combination of the foregoing. Any combination of one or more computer readable medium(s) may be utilized. The computer readable medium may be a computer readable signal medium or a computer readable storage medium. Examples of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

While the inventive concepts has been shown and described with reference to specific embodiments, it should be understood by those skilled in the art that various changes in form and detail may be made therein without departing from the spirit and scope of the inventive concepts.

What is claimed is:

1. A dialysis treatment simulation system, comprising:
a treatment simulator that simulates an event notification related to an interaction between a dialysis treatment machine and a patient;
a computing module that generates a request for a user action in response to the simulated event notification; and
a user interface that outputs the simulated event notification and the request for the user action to an output device and provides a received user response to the computing module.

2. The dialysis treatment simulation system of claim 1, wherein the computing module generates a multiple choice question and one or more possible answers to the multiple choice question, and wherein the received user response includes a user-selected answer of the one of the computer module-generated possible answers.

3. The dialysis treatment simulation system of claim 1, wherein the computing module generates a question and a blank field, and wherein the user action includes entering a response to the question in the blank field.

4. The dialysis treatment simulation system of claim 1, wherein the computing module processes a response to the request for the user action input to the user interface by an operator.

5. The dialysis treatment simulation system of claim 1, wherein the treatment simulator generates simulation data related to the interaction between the dialysis treatment machine and the patient, the simulation data simulating treatment parameters related to the interaction between the dialysis treatment machine and the patient.

6. The dialysis treatment simulation system of claim 5, wherein the event notification is displayed in response to a simulated treatment parameter exceeding a treatment parameter threshold.

7. The dialysis treatment simulation system of claim 1, wherein the event notification simulates at least one of an alarm notification, a warning notification, or a status advisory notification.

8. The dialysis treatment simulation system of claim 7, wherein the event notification simulates an abnormal event related to a dialysis treatment.

9. The dialysis treatment simulation system of claim 1, wherein the user interface provides the event notification with a graphical element to a visual display.

10. The dialysis treatment simulation system of claim 9, wherein the graphical element includes at least one of a window, a menu, a radio button, a check box, a status box, an icon, or a display field.

11. The dialysis treatment simulation system of claim 1, further comprising a results processor that determines from the received user response a competence level of a user with respect to operating the dialysis treatment machine.

12. The dialysis treatment simulation system of claim 1, wherein the output device is at least one device selected from a computer display, a tablet computer, and a mobile device.

13. The dialysis treatment simulation system of claim 1, further comprising a timer that determines whether a user responds to a presented question within a predetermined period of time.

14. The dialysis treatment simulation system of claim 1, wherein the system is operated by at least one of a healthcare practitioner, a dialysis patient, or a technical service personnel for training on the operation of the dialysis treatment machine.

15. A computer-implemented method for performing a dialysis treatment simulation, comprising:
generating an event notification that simulates an event notification related to an interaction between a dialysis treatment machine and a patient;
generating a request for a user action in response to the simulated event notification;
outputting the simulated event notification and the request for the user action to an output device; and
processing a received user response to the request for the user action.

16. The method of claim 15, wherein outputting the request includes displaying, at a treatment display, a menu of options for a user to select from.

17. The method of claim 16, wherein at least one of the menu options corresponds to a correct action for addressing the displayed simulated event notification.

18. The method of claim 15, wherein generating an event notification comprises executing computer code that simulates the event notification.

19. A method of simulation for training a trainee of a dialysis treatment machine, comprising:
displaying, at a display, an event notification related to a simulated dialysis treatment;
performing a response activation;
displaying, at the display, a question regarding the displayed event notification; and
processing a response to the question.

20. The method of claim 19, wherein performing the response activation includes selecting a button at the display.

21. The method of claim 19, wherein displaying the question includes displaying, at the display, a menu of options for a user to select from.

22. The method of claim 19, further comprising:
generating a multiple choice question and one or more possible answers to the multiple choice question; and
selecting an answer of the one or more possible answers as the response.

23. The method of claim 19, further comprising:
generating a question and a blank field; and
entering the response at the blank field.

24. The method of claim 19, wherein the event notification simulates a notification of an event related to an interaction between the dialysis treatment machine and a patient.

25. The method of claim 24, further comprising generating simulation data related to the interaction between the dialysis treatment machine and the patient, the simulation data simulating treatment parameters related to the interaction between the dialysis treatment machine and the patient.

26. The method of claim 19, wherein the event notification simulates at least one of an alarm notification, a warning notification, or a status advisory notification.

27. The method of claim 26, wherein the event notification simulates an abnormal event related to a dialysis treatment.

28. The method of claim 19, further comprising determining from the response a competence level of a user entering the response with respect to user operating the dialysis treatment machine.

29. The method of claim 19, further comprising determining whether a user responds to a presented question within a predetermined period of time.

30. A system for training a trainee about a self-care medical procedure, the training system comprising:
a computing module that includes an operation to be learned related to a dialysis treatment, the computing module constructed and arranged to generate a request for a user action related to the operation to be learned;
a simulated treatment display screen that displays the request; and
a results processor that processes a response to the request and provides a training result in response to the processed response.

31. A computer program product for simulation, the computer program product comprising:
a computer readable storage medium having computer readable program code embodied therewith, the computer readable program code comprising;
computer readable program code configured to simulate an event notification related to an interaction between a dialysis treatment machine and a patient;
computer readable program code configured to generate a request for a user action in response to the simulated event notification;
computer readable program code configured to output the simulated event notification and the request for the user action to an output device; and
computer readable program code configured to process a received user response to the request for the user action.
